(19) United States
(12) Patent Application Publication
(10) Pub. No.: US 2006/0236542 A1
(43) Pub. Date: Oct. 26, 2006

(54) Method of making star gear for constant-velocity joint

(75) Inventors: Jurgen Walz, Frickenhausen (DE); Ralph Masselhauser, Geislingen an der Steige (DE)

Correspondence Address: THE FIRM OF KARL F ROSS, 5676 RIVERDALE AVENUE, PO BOX 900, RIVERDALE (BRONX), NY, 10471-0900, US

(73) Assignee: EMAG Holding GmbH

(21) Appl. No.: 11/411,008

(22) Filed: Apr. 25, 2006

(30) Foreign Application Priority Data
Apr. 25, 2005 (DE) 102005019160.6

(51) Int. Cl. B23P 15/14

(52) U.S. Cl. 29/893.35

(57) ABSTRACT

A star gear for a constant-velocity joint is made by first forming in a steel blank without material removal a center hole of noncylindrical shape and defining an axis. Then a complementary mandrel is fitted in the formed center hole. Finally a plurality of outwardly open grooves are cut into an outer surface of the blank in a chip-removing process while the blank is on the mandrel.

### FIELD OF THE INVENTION

The present invention relates to a constant-velocity joint. More particularly this invention concerns a method of making the star gear for such a constant-velocity joint.

### BACKGROUND OF THE INVENTION

A typical constant-velocity joint such as used in a front-wheel-drive vehicle comprises a star gear splined to the outboard end of a drive shaft and formed with an array or radially outwardly generally axially extending grooves, an outer output cup coaxially receiving the star gear and formed with a complementary array of radially inwardly open seat-forming grooves, and an array of balls seated in the grooves and rotationally linking the star gear to the cup. The drive shaft is connected, typically via another constant-velocity joint, to the transmission and the output cup is fixed to the respective wheel. This way torque is transmitted from the drive shaft to the wheel, but the wheel can pivot about vertical and horizontal axes relative to the outer end of the drive shaft while still receiving torque. Similar joints may be provided for the rear wheels in vehicles with independent suspension, and may even be provided at front and rear ends of front and rear drive shafts for a total of as many as ten such joints in a vehicle.

Star gears for such a constant-velocity joint are preferably preformed of carbon steel by hot-forging. After cooling, the inner bore, planar end faces and outer surface are machined by turning. Subsequently the ball groove/seats are produced by milling or broaching. The machining of the inner plug-profile is carried out by broaching or reaming followed by inductive hardening.

Furthermore it is known that blanks for fixed joints are fabricated from hardened steel that can be cold worked. Pressing of the shape of the ball-bearing slides and of the outer diameter is completed by transverse extrusion. Subsequently to the pressing, the bore and the bearing surfaces are machined by turning. Afterwards the inner plug-profile is machined by broaching or thrusting. Then the star gears are hardened.

U.S. Pat. No. 6,665,936 describes a process for finishing the ball star of a constant-velocity joint where the ball star has an annular bearing surface for mounting in a output cup, and has a plurality of essentially axial running grooves provided for the balls. The balls are arranged in the ball seats of the output cup and transmit torque between the ball cup and the ball star. In order to be able to finish such ball stars quickly, economically and as fully automatically as possible, both the ring-shaped bearing surface provided for mounting in the output cup as well as the grooves provided for the balls are produced by a hard-rotary turning operation.

In all known methods the inner bore and the bearing surfaces are machined by turning after hot forging or cold shaping and subsequently the core profile is produced by broaching or reaming. This is an expensive sequence of steps.

### OBJECTS OF THE INVENTION

It is therefore an object of the present invention to provide an improved method of making star gear for constant-velocity joint.

Another object is the provision of such an improved method of making star gear for constant-velocity joint that overcomes the above-given disadvantages, in particular that is relatively simple, yet which produces a high-quality and accurately dimensioned product.

### SUMMARY OF THE INVENTION

A star gear for a constant-velocity joint is made according to the invention by first forming in a steel blank without material removal a center hole of noncylindrical shape and defining an axis. Then a complementary mandrel is fitted in the formed center hole. Finally a plurality of outwardly open grooves are cut into an outer surface of the blank in a chip-removing process while the blank is on the mandrel.

Due to the applicable production of the plug-profile of the star gear, the machining steps of broaching or reaming can be eliminated so that after the first step the star-gear blank or workpiece can be positioned on a mandrel for further machining without having to apply different procedure steps with corresponding clamping of the workpiece, starting from the production of the plug-profile to the machining of the other surfaces. This results not only in a shorter machining time but also improves the accuracy of the final shape since, subsequent to the initial shaping without material removal of the blank, the star-gear blank can be positioned on a mandrel corresponding to the shape of the drive shaft on which the finished star gear will be carried, and the blank stays on this mandrel while the following machining steps are carried out. In this manner an exact positioning of both the outer bearing surface and the grooves of the blank is ensured so that tolerances can be very tight and the machining time is significantly shortened.

In order to improve the positioning of the star-gear blank on the mandrel, it is. convenient to create at least at one axial end of the constant-velocity joint blank a bearing surface by shaping without material removal. This end face extends perpendicular to the axis of symmetry of the workpiece defined by the center hole. This way the star-gear blank on the mandrel can be pressed against an abutment surface or shoulder of the mandrel so fixation of the star-gear blank during further machining is improved.

To produce constant velocity joints allowing some axial shifting with a ball-shaped outer bearing surface for the outer cup in a wheel-mounted ball retainer, the invention provides for the bearing surface to be created by machining by means of a metal-cutting procedure. Typically it is done in a lathe by turning.

The seat grooves are preferably produced by milling, typically in a roughing mill and subsequently in a finishing mill.

In an advantageous embodiment of the invention, a chamfer at where each groove merges with the outer bearing surface is produced during the machining of the groove during the rough-milling step used in initial machining of the grooves, thereby eliminating an additional step.

Finally the star-gear blank is hardened after the non-cutting and the cutting machining. It is carburized or inductively hardened.

### BRIEF DESCRIPTION OF THE DRAWING

The above and other objects, features, and advantages will become more readily apparent from the following description, reference being made to the accompanying drawing in which:

FIG. 1 is a largely schematic end view illustrating the method of this invention; and

FIG. 2 is a block diagram of the method.

### SPECIFIC DESCRIPTION

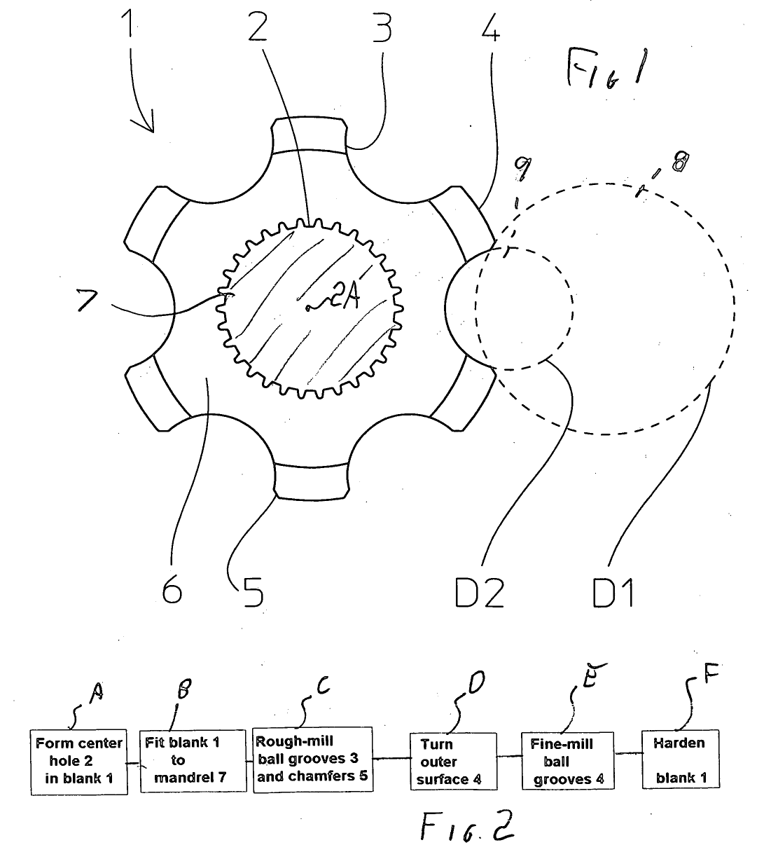

As seen in FIG. 1, a star-gear blank 1 has an inner central splined hole 2 formed by hot or cold shaping with transverse extrusion (FIG. 2 step A). After production of this blank 1 it is fitted (step B) to a mandrel 7 that fits complementarily in the hole and that in fact corresponds exactly to the shape of the drive shaft to which the finished star gear will be fitted. Then ball-seat grooves 3 are cut in the blank 1 in a two-part milling operation, that is with rough milling (step C) first and then finish milling (step E). An outer bearing surface 4 centered on an axis A of the recess is formed in a lathe by turning (step C). Chamfers 5 between the edges of the generally axially extending grooves 3 and the bearing surface 4 are cut into the workpiece 1 during the rough-milling step. These chamfers 5 are produced during rough-milling step C, so that a further additional step is avoided. Milling tools 8 and 9 of large and small diameters D1 and D2 are used for forming the seats 3 and chamfers 5. Finally the blank 1 is hardened (step F).

An end face 6 of the star-gear blank 1 is formed like the hole 2 by deformation without removal of material and bears on an unillustrated shoulder of face of the mandrel 7 so that the blank 1 is perfectly positioned during milling and turning of the grooves 3, outer surface 4, and chamfers 5. This end face 6 lies in a plane extending perpendicular to the longitudinal axis 2A of the center hole 2 of the workpiece 1.

We claim:

1. A method of making a star gear for a constant-velocity joint, the method comprising the steps of sequentially:
forming in a steel blank without material removal a center hole of noncylindrical shape and defining an axis;
fitting into the formed center hole a complementary mandrel; and
cutting in an outer surface of the blank in a chip-removing process a plurality of outwardly open grooves while the blank is on the mandrel.

2. The method defined in claim 1, further comprising the step before fitting of the mandrel into the center hole of:
forming a perpendicular and axially directed end face on the blank without material removal.

3. The method defined in claim 1, further comprising the step after fitting of the mandrel into the center hole of:
cutting the outer surface of the blank so that it is centered on the blank axis.

4. The method defined in claim 3 wherein the outer surface is cut by a turning operation.

5. The method defined in claim 1 wherein the grooves are cut by a milling operation.

6. The method defined in claim 5 wherein the milling operation includes a coarse-milling operation followed by a finish-milling operation.

7. The method defined in claim 1, further comprising the step after fitting of the mandrel into the center hole of:
cutting chamfers on edges of the grooves in a material-removing machining operation.

8. The method defined in claim 1, further comprising the step after cutting the grooves in the blank of:
hardening the blank.
